(19) United States
(12) Patent Application Publication
(10) Pub. No.: US 2007/0252098 A1
(43) Pub. Date: Nov. 1, 2007

(54) Method for Calibrating Analog Controlling, Electrically Actuatable Hydraulic Valves

(75) Inventors: Robert Schmidt, Kelkheim (DE); Mirco Loos, Elversberg (DE); Andreas Neu, Kuhardt (DE); Andreas Reis, Frankfurt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/582,069

(22) PCT Filed: Nov. 18, 2004
(86) PCT No.: PCT/EP04/53001

§ 371 Date: Apr. 17, 2007

(30) Foreign Application Priority Data
Dec. 8, 2003 (DE) 10357592.8

(51) Int. Cl. F16K 31/02

(52) U.S. Cl. 251/129.01

(57) ABSTRACT

The invention describes a method and a pressure control device for the valve calibration of an analog controlling, electrically actuatable hydraulic valve (2, 2′, 3, 3′, 3″, 3′″) in a device with at least one externally supplied pressurization unit (1, 1′) and with pressure sensors (9, 10, 10′, 10″, 10′″), with said device comprising several pressure control circuits (A, B, C, D) and in particular several brake circuits (I., II.), and with at least some pressure control circuits being connected to a pressure sensor associated with this circuit and to inlet and outlet valves. In this method, several calibration routines are performed to generate and store automatically established calibration data, and during or prior to each calibration routine, the externally supplied pressurization unit (1, 1′) produces pressure in at least one pressure control circuit (A, B, C, D), and calibration data is recorded for one or several analog controlling hydraulic valves by using the pressure that has built up.

The invention relates to a method according to the preamble of claim 1 and a device according to claim 7.

It is known in the art to employ analog controlling, electrically actuatable hydraulic valves for the purpose of hydraulic pressure control in ABS control devices for motor vehicle brake systems, but also in so-called driving dynamics controllers equipped with additional functions such as ESP, etc.

So-called analog/digital valves are used in more recent generations of hydraulic control devices. An analog/digital valve is a switching valve that is so operated that it inheres analog control characteristics. This valve is designed in a manner that it can be operated both in analog and digital ways.

EP 0 813 481 B1 (P 7565) discloses a method for detecting the operating point of the valve, in particular for determining the pressure ratios from the current variation of the valve actuating current.

In principle, the coil current can be used to adjust the pressure gradient built up by the valve. However, a complicated calibration is necessary to this end, as is known. As described e.g. in WO 01/98124 A1 (P 9896), characteristic curves for the valves are established for this purpose, and nominal currents are adjusted which are calculated by means of the characteristic curves depending on the desired pressure gradient. Consequently, the volume flow Q with respect to characteristic line f depends on the differential current Δp and on current I.

DE 102 214 56 A1 discloses a calibration method for analogized inlet and separating valves according to the preamble of claim 1. The calibration method described in this publication does not manage without the use of a so-called testing rod, therefore necessitating a testing device that has a correspondingly sophisticated design for depressing the brake pedal.

It is, however, complicated and disadvantageous to prepare individual calibration data or characteristic curves for each valve during manufacture, for example, by manually fitting the brake control unit into a device comprising a testing rod. It is further disadvantageous when e.g. the electronics of an electrohydraulic device, which contains these valves, must be exchanged at a later point of time for maintenance purposes. The calibration data memorized therein will usually get lost in this case. In view of the above, the object to be achieved involves providing a method, which allows preparing correspondingly suitable calibration data or characteristic curves in a simpler fashion.

This object is achieved by the method according to claim 1.

The calibration of the invention is carried out by means of the device automatically by using the hydraulic energy of the pressurization unit controlled by extraneous force (for example, a piston pump driven by a motor). The calibration is preferably performed only after the production of the valve or the electrohydraulic device in the object into which the valve or the electrohydraulic device is mounted. Thus, it is possible to perform the calibration e.g. only after fitting the control unit into a motor vehicle.

This method entails considerably less costs than preparing calibration data at the assembly line, because a transfer of the calibration data into the electronic control connected to the valve is no longer necessary.

Preferably, the electrohydraulic control device in which the valves are mounted comprises several hydraulic pressure control circuits, which can be separately driven by means of inlet and outlet valves. A brake cylinder is associated with each circuit in a particularly preferred manner. Regarding the example of a brake unit, each pressure control circuit is allocated to a motor vehicle wheel.

The electrohydraulic control device comprises on the inlet side preferably one pressure sensor, e.g. in the area of the master cylinder (Thz—tandem master cylinder).

Several or all of the circuits are preferably equipped with further ‘circuit pressure sensors’, which enable individual pressure measurement in each hydraulic circuit.

A coil current which is essentially associated with a determined differential pressure can be defined in the solenoid valves to be calibrated according to the invention, these valves concerning normally open inlet valves of a brake control unit in particular.

In addition, the method can be used favorably to monitor the proper functioning of the device.

After the installation of the brake control unit, the described calibration routine is expediently carried out one time during the first initiation or with each ignition cycle.

Preferably, a motor vehicle into which the brake unit is especially mounted is at standstill while the calibration routine is performed.

It is favorably monitored during the process whether a determined predefined maximum time is not exceeded when filling the pressure accumulator.

It is furthermore favorable that it is monitored whether the established characteristic curve or the established calibration data lie within a predefined range of validity.

Further preferred embodiments can be seen in the sub claims and the following description of the Figures.

Hereinbelow, the invention will be explained in detail with reference to an example.

### IN THE DRAWINGS

FIG. 1 is a schematic view of a brake unit with analog actuatable valves, and

FIG. 2 shows a diagram for illustrating the pressure variations and the valve current.

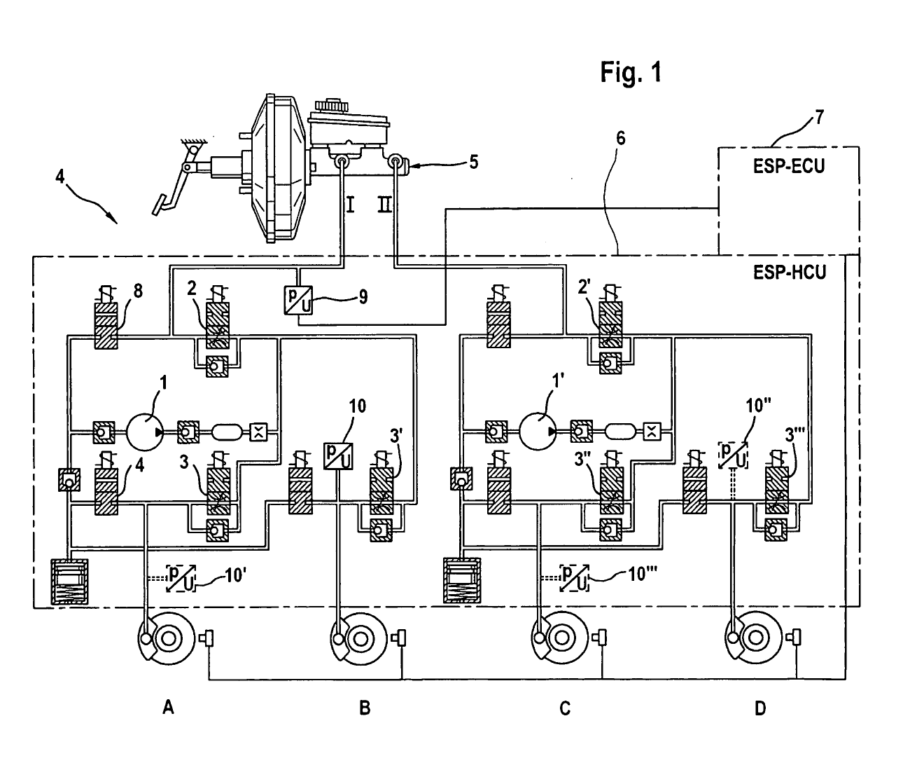

Referring to FIG. 1, tandem master cylinder 5 is connected to valve block 6 of an electronic motor vehicle brake system. Electronic unit 7 comprises a microcontroller system used to electronically control or measure the actuators and sensors provided in the valve block. Valve block 6 comprises two brake circuits I and II. Each brake circuit comprises two wheel pressure circuits with respectively one inlet valve 3 and one outlet valve 4. Reference numeral 2 designates a normally open separating valve and reference numeral 8 designates a normally closed electronic changeover valve. An inlet pressure sensor 9 is positioned in the hydraulic line leading to the master cylinder 5. One or more pressure sensors 10, 10′, 10″, 10′″ are arranged in the wheel pressure circuits. Pump 1 is used for the independent pressure increase, such as in the TCS or ESP case.

For calibration, valve 2 is closed and valve 8 opened initially in a first step. Pump 1 is activated. Valve 3 is closed after pressure buildup of roughly 5 bar in the pressure circuit A (calibration circuit). Valve 3′ in circuit B remains open until a pressure of roughly 180 bar is reached in circuit B. The pressure in circuit A is greater zero to prevent undesirable effects (e.g. cavitations) during the actual calibration.

In the next step, the pump is switched off and valve 8 is closed. The pressure in circuit B is then initially shut in similar to a pressure accumulator.

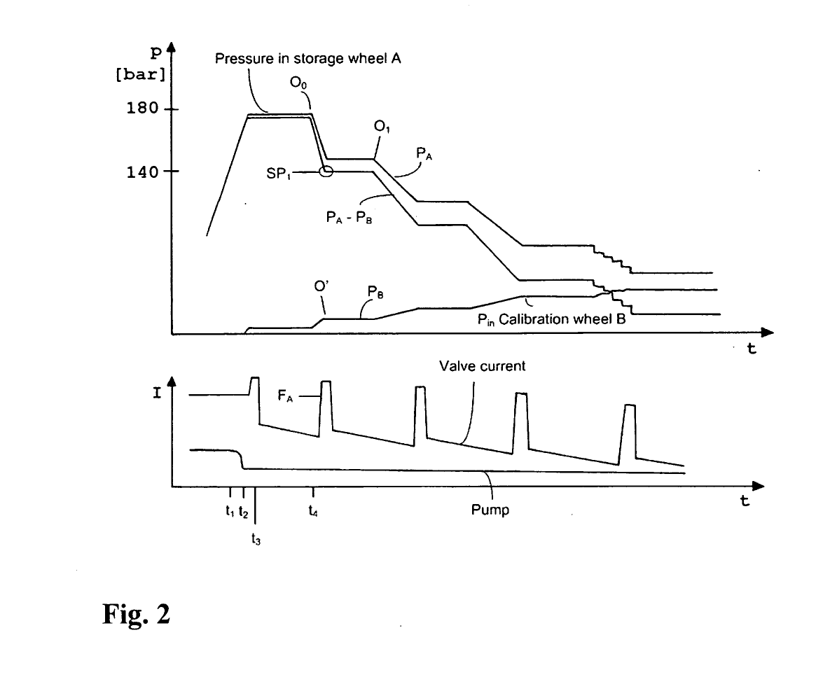

The further process will now be explained referring to FIG. 2. The pump is switched off at time t1. The pressure in the ‘accumulator wheel’ B amounts to 180 bar approximately. At time t2, the valve current of the valve 3 under calibration is increased at the, ‘calibration wheel’ A to such an extent that the valve is tightly closed. Subsequently (starting with t3 to t4), the current is slowly decreased. The valve meanwhile opens, at point ‘O₀’, so that the pressure drops in the accumulator wheel A. Accordingly, the pressure rises in the calibration wheel B in the area ‘O′’. When a differential pressure (PB-PA) of 140 bar is reached, the reference point SP₁ is acquired and stored. At point SP1, valve 3 is closed again due to a steep current increase (flank F1). The pressure variation is stopped hereby. Subsequent thereto, pressure decrease is used to search for point O₁, where the valve is just bringing about a change in pressure again. For example, this can be detected by monitoring that a predefined threshold value is not reached. The opening current at point O₁ is memorized as being linked to the pressure at reference point SP₁. Thereafter, the method is continued in a corresponding fashion for measuring further reference points (SP₂, O₂), (SP₃, O₃), . . . , (SPₙ, Oₙ). A calibration curve DeltaP (I) for valve 3 is obtained.

The method is then repeated for the remaining wheel pressure circuits B to D, and an adjacent wheel pressure circuit is used as an accumulator circuit in each case. It is this way possible to measure calibration curves for all inlet valves.

For example, the method can be secured in addition by checking whether
all pressure sensors furnish plausible signals,
the vehicle is at standstill during the calibration time,
a maximum time for pressure increase is not exceeded,
the characteristic curve found lies within certain limits (e.g. maximum characteristic curve, minimum characteristic curve, minimum and maximum gradient).

It is furthermore expedient to protect the calibration data or the data of the characteristic curves by check sums.

1-7. (canceled)

8. A method for valve calibration of an analog controlling, electrically actuatable hydraulic valve in a device, in particular an electrohydraulic pressure control device (4), including at least one externally supplied pressurization unit (1, 1′) and pressure sensors (9, 10, 10′, 10″, 10′″), with said device comprising several pressure control circuits (A, B, C, D) as well as especially several brake circuits (I., II.), and with at least some pressure control circuits being connected to a pressure sensor associated with this circuit and to inlet and outlet valves, the method comprising:
performing two or more calibration routines to generate and store automatically established calibration data;
during or prior to each calibration routine, producing pressure by an externally supplied pressurization unit (1, 1′) in at least one pressure control circuit (A, B, C, D); and
recording calibration data for one or more analog controlling hydraulic valves by using pressure that has built up.

9. A method according to claim 8, wherein a first pressure control circuit (A) is used as a pressure accumulator and the calibration data of a valve is recorded in at least one additional pressure control circuit (B) which is other than the first circuit.

10. A method according to claim 9, wherein pressure is built up also in least one additional circuit with the valve (3′) being calibrated by the externally supplied pressurization unit, and this pressure is lower than the pressure in the first circuit.

11. A method according to claim 8, wherein the calibration data comprises the differential pressure or variables that can be derived therefrom, and the differential pressure at which the opening current of the valve shall be measured is initially adjusted by opening the same valve, with hydraulic volume of the first circuit being discharged into the additional circuit, whereupon the opened valve will be closed again in full extent.

12. A method according to claim 11, wherein the valve is slowly opened at a differential pressure previously adjusted and measured by variation of the valve current, and the opening current is measured when the pressure in the first or the additional circuit or the differential pressure has changed by a fixed predefined degree.

13. A method according to claim 8, wherein for establishing the calibration data, several test values or several measuring routines are taken into account in order to improve accuracy or for redundancy.

14. Pressure control device for electronic brake systems of driving dynamics control systems, the pressure control device comprising:
a microcomputer which implements a method including;
performing two or more calibration routines to generate and store automatically established calibration data;
during or prior to each calibration routine, producing pressure by an externally supplied pressurization unit (1, 1′) in at least one pressure control circuit (A, B, C, D); and
recording calibration data for one or more analog controlling hydraulic valves by using pressure that has built up.
